(19) United States
(12) Patent Application Publication
(10) Pub. No.: US 2018/0147449 A1
(43) Pub. Date: May 31, 2018

(54) SCHEDULING EXERCISE EQUIPMENT BASED ON MEDICAL DATA

(71) Applicant: International Business Machines Corporation, Armonk, NY (US)

(72) Inventors: Ali Y. Duale, Poughkeepsie, NY (US); Shailesh R. Gami, Poughkeepsie, NY (US); Louis P. Gomes, Poughkeepsie, NY (US); Rajaram B. Krishnamurthy, Pleasant Valley, NY (US)

(21) Appl. No.: 15/895,284

(22) Filed: Feb. 13, 2018

Related U.S. Application Data
(63) Continuation of application No. 15/348,066, filed on Nov. 10, 2016.

(51) Int. Cl. A63B 24/00; A63B 69/12; G06Q 10/02; A63B 69/00

(52) U.S. Cl. CPC A63B 24/0075; A63B 69/12; G06Q 10/02; A63B 2230/01; A63B 2024/0081; A63B 2230/40; A63B 69/0028

(57) ABSTRACT

A method for scheduling and reserving in real-time the use of exercise equipment at a fitness center. One or more processors receive a user profile including data, wherein the data includes medical data, schedule preferences, and fitness goal data of a user. One or more processors compare the user profile to a plurality of profiles included in a repository, wherein individual profiles of the plurality of profiles include medical data, schedule preferences, fitness goal data, and a corresponding workout plan. One or more processors determine whether the user profile matches, to a predetermined degree of similarity, to at least one individual profile. Having determined that the first user profile matches, one or more processors generates a workout plan for the user based on at least one individual profile and the corresponding workout of the profile. One or more processors create a schedule for the workout plan.

### BACKGROUND OF THE INVENTION

The present invention relates generally to the use of smart exercise equipment, specifically including computer network systems communicating with the smart exercise equipment to provide valuable information to the user of the smart exercise equipment.

Fitness centers are typically equipped with a multitude of exercise equipment, ranging from machines targeting cardiovascular health, such as treadmills, elliptical cross trainers, stationary bicycles, and steppers, to machines targeting muscle growth, including leg press machines, bicep curl machines, ab crunch machines, and butterfly machines. It is not atypical to find that a member of a fitness center is unable to use such exercise equipment for a variety of reasons, but the most pertinent reason that a member is likely unable to use a machine is because of unavailability. Even if the fitness center is equipped with the optimum number of exercise machines, there may be periods of time throughout the day where a significant majority of members utilize the center, which can be overwhelming to some of the members wishing to exercise.

### SUMMARY

According to an aspect of the present invention, there is a method, computer program product and/or computer system for performing the following operations (not necessarily in the following order): (i) determining, by machine logic, a first session-time parameter value, based, at least in part, upon the physiological data set, with the first session-time parameter value representing a recommended time duration of a first exercise session by the first user on an exercise resource of a first type; and (ii) scheduling, by machine logic, a plurality of exercise sessions respectively corresponding to a plurality of users including the first user, for a set of exercise resource(s) of the first type, with the scheduling being based, at least in part, upon the first session-time value.

According to an aspect of the present invention, there is a method, computer program product and/or computer system for use with an exercise resource that can accommodate a maximum of N users at a time, where N is an integer greater than zero, and that performs the following operations (not necessarily in the following order): (i) scheduling, by machine logic, a plurality of users to a plurality of available time intervals of a first exercise resource such that no more than N initially-scheduled user(s) are scheduled on the first exercise resource during any time interval of the available time intervals; (ii) receiving, over a communication network, a request by a first user to use the first exercise resource during a first time interval; and (iii) responsive to receipt of the request, determining, by machine logic, that N initially-scheduled user(s) are already scheduled to be using the first exercise resource during the first time interval; and (iv) on condition that N user(s) are already scheduled, placing, by machine logic, the first user on a wait list associated with the first time interval and the first exercise resource.

Embodiments of the present invention disclose a method, computer program product, and system, the method providing that one or more processors receive a first user profile including data, in which the data of the first user profile includes medical data, schedule preferences, and fitness goal data of a first user. One or more processors compare the first user profile to a plurality of profiles included in a repository, in which individual profiles of the plurality of profiles include medical data, schedule preferences, fitness goal data, and a corresponding workout plan. One or more processors determine whether the first user profile matches, at least one profile of the plurality of profiles included in a repository, to a predetermined degree of similarity. Responsive to determining that the first user profile matches to at least one profile of the plurality of profiles included in a repository, one or more processors generate a workout plan for the first user based on at least one profile and the corresponding workout of the one profile, and one or more processors create a schedule for the workout plan of the first user based on the workout plan and the data of the first user profile.

### BRIEF DESCRIPTION OF THE FIGURES

FIG. 1 is a functional block diagram illustrating a computer network system environment, in accordance with an embodiment of the present invention.

FIG. 2 is an illustration of a portion of an exemplary fitness center, in accordance with an embodiment of the present invention.

FIG. 3 is a flowchart illustrating operational steps of a generate plan module within computer network system environment, in accordance with an embodiment of the present invention.

FIG. 4 is a flowchart illustrating operational steps of a reserve and monitor module within computer network system environment, in accordance with an embodiment of the present invention.

FIG. 5 depicts a block diagram of components of a computing device executing the generate plan module and the reserve and monitor module within the computer network system environment of FIG. 1, in accordance with an embodiment of the present invention.

### DETAILED DESCRIPTION

Most fitness centers are equipped with various exercise equipment, also referred to as “exercise machines” or “machines,” to serve wide customer needs. Many pieces of exercise equipment are limited in use due to the available space, popular demand, and financial resources of the company managing the fitness center. Even with an optimum amount of exercise equipment, usage during rush hours can be overwhelming and some customers, also referred to herein as members, or users, will have to either wait, use a different type of exercise equipment, or come back to the fitness center at different time. This scenario is inconvenient to many fitness center users when the right equipment is not available for the intended workout. In some cases, exercise machine scheduling may require manual intervention.

This problem can be solved by computerizing the fitness center and connecting each piece of exercise equipment to the central computer network. Each piece of exercise equipment can have a sensor that sends data to central computer system when a user is identified and uses an exercise machine. An application (App), operating on the fitness center computer keeps track of each exercise machine in use, the identity of who uses the exercise machine, and for how long a user, or member uses the exercise machine, and may also monitor and collect additional data during performance of a workout plan by a fitness center member. Members interested in using certain workout equipment may make use of the App to reserve available exercise equipment via Fitness center computer system. In addition to the computer system and sensors, a corresponding App for a smart device (smart phone or smart watch or tablet or computer) is included, with which a customer (member) can see the next available slot on any exercise machine and reserve it before even reaching to the fitness center. The process begins with setting up a user profile and goal information. A user logs in and is identified, receiving a confirmation of the reservation at the fitness center in order to avoid the practice of reserving, but not using the exercise equipment. If a reservation does not get confirmed or the exercise machine sits idle (no show), then persons who have made later reservations for the exercise machine are notified (via a smart device) of the availability, and can opt to take that spot. The application monitors reservation and usage of exercise equipment for repeated “no show” offenders, and may not allow the frequently repeated offenders to remotely make advance reservations during rush hours. The fitness center employees can override the reservations and scheduled machine usage and conflicts. The App on a smart device allows a user to Track Real-time machine availability and request a machine time, and Analytics helps to optimize the usage of the exercise equipment.

An analytic engine, which includes modules to generate workout plans, reserve exercise equipment, monitor exercise performance and monitor equipment usage, of the central computer system will look for similar profile and goal information from other previously established (members) users, and generate an Initial Fitness-program, or workout plan. Based on the workout plan, the analytic engine creates a schedule. A user can either accept the workout plan and schedule or make changes, and this information gets sent back to the analytic engine for on-going monitoring. The analytic engine monitors the Fitness-program and recommends changes with new scheduling when necessary.

The analytic engine helps to create customized fitness program and schedule. Analytics built into the analytic engine monitor and provide an adjusted new workout plan and schedule based on usage of exercise equipment and the user's goals. A user may have missed some days or used one machine more than another for various reasons, and this may require adjusting the new schedule. In the event where a machine becomes unavailable (e.g. the machine breaks down), Analytics recommends a machine that falls within the same type of exercise (for example ‘cardio’-type, or ‘weight bearing’-type).

A smart device is notified if a machine time becomes available. The App allows a member (user, customer), to schedule and reserve equipment-time in real-time. The smart device helps to make a connection to an exercise equipment's' sensors and identifies the member and the exercise equipment, and may transmit data to the central computer that includes the machine usage. Periodically, the analytic engine provides the user with a progress report and recommendations to improve the fitness of the member and stay on track to achieve member goals, based on workout activity performed by the user, and the analytic engine provides recommendations to enhance fitness center performance, equipment utilization, and possible future equipment requirements. In some embodiments of the present invention, a user can upload workout progress reports to social media to share with others.

Embodiments of the present invention include some or all of the following: (i) automate the scheduling a workout plan according to the user preference, usage patterns and availability of machine time; (ii) use smart device to allow user to pick computer generated schedule; (iii) track Real-time machine availability and schedule; (iv) allow user to select his/her own schedule; (v) optimize the usage of machines; and (vi) enhance and increase the efficiency of equipment and fitness center.

Embodiments of the present invention have the following advantages: (i) automate and customize scheduling a workout plan based on a usage pattern of a user, user's preference and availability of equipment; (ii) allow the user to schedule in advance; (iii) use a smart device (Phone, watch, tablet, etc.) to interface with a computer system, view, and schedule a workout plan while on the go; (iv) use a smart device (watch, wearable device) to register use of an exercise machine while at a fitness center; (v) use the collected data from the user's workout, and provide feedback and suggestions to the user; (vi) use the collected data to improve fitness center equipment requirements, (i.e. invest in the proper equipment); (vii) generate a physical activity report at certain interval for user analysis and necessary action; (viii) upload a physical activity report to social media in order to share with friends and family; and (ix) optimize equipment usage.

Embodiments of the present invention further aim to connect all exercise machines within a fitness center to a central computer system, which allows the central computer system to log the usage of each equipment and who is using the equipment in real-time. When a user uses the equipment, the user gets connected with the exercise equipment via either a RFID key for direct communication, a wearable or other device, using a wireless connection such as Bluetooth® or Wi-Fi. The App operating on the computer system tracks the usage of each piece of exercise equipment, the performance data of the user, and the usage pattern of the user.

An application program, or App, for a smart device is also developed to access the real-time schedule of the fitness center computer system. During peak usage of the fitness center, the central computer system provides multiple options to the user, including: (a) allowing the user to make their own decisions based on currently free exercise equipment; (b) automating a workout schedule based on a particular user's usage pattern and availability of equipment; and (c) allowing users to interact and provide their choice of exercise equipment, and generate a new workout schedule, while provide all possible available options to choose.

Embodiments of the present invention enable interaction with the App on the central computer system to setup the schedule well in advance. Upon availability of the exercise equipment, a computer system sends a signal/SMS to a particular registered device in order to inform interested users that exercise equipment is available. A user can then either accept the time slot provided, and reserve for use of the exercise equipment, or reject the message and may request a new time slot in which to use the exercise equipment. Flexible workout scheduling informs a user that no one is waiting to use the exercise equipment and use of the exercise equipment can be continue.

Embodiments of the present invention recognize that fitness centers include various and numerous exercise machines for their members', workouts, and often experience periods of high member demand for use of at least some exercise machines. High member demand situations result in long wait times and, in some instances, members, sometimes referred to as users or current members, may omit certain workout activities, or depart prematurely, affecting their progress and achievement of goals. Fitness centers attempt to mitigate high member demand situations by investing more money in larger fitness centers with more exercise equipment or by attempting to utilize various scheduling mechanisms to alleviate high member demand situations.

Embodiments of the present invention provide a network environment of exercise equipment enabling scheduling and reservation of exercise machines to improve efficiency, utilization and availability of exercise equipment to members at a desired or planned time. At certain periods of time during the day, a fitness center may be crowded, depending on when members choose to attend, or based on the members' particular training schedule. Fitness center members are often faced with long wait times to use particular exercise machines that are in high demand. In response to long wait times, members may divert from ideal workout activity to avoid the long wait times, potentially affecting achievement of goals and objectives.

Fitness center operators prefer high levels of membership and high utilization of their fitness centers, but must find a way to address periods of high demand for particular exercise equipment, and mitigate the frustration felt by members that are consistently unable to perform all of the recommended workout activity, as defined by the members' workout plans. Embodiments of the present invention provide a way of addressing the periods of high demand on certain pieces of exercise equipment, sometimes referred to as exercise machines, and mitigating the frustration felt by affected fitness center members. Embodiments of the present invention include features such as: reserving, in advance, at least one exercise machine for a pre-determined period of time; providing the member with a recommended workout plan, including a schedule of exercise equipment usage, based on the member's availability, exercise equipment availability, and member goals; modifying a rejected workout plan and schedule recommended by certain embodiments of the present invention; identifying fitness center members and individual exercise machines; displaying data collected from a workout as feedback to a member; and creating and updating a profile for the member.

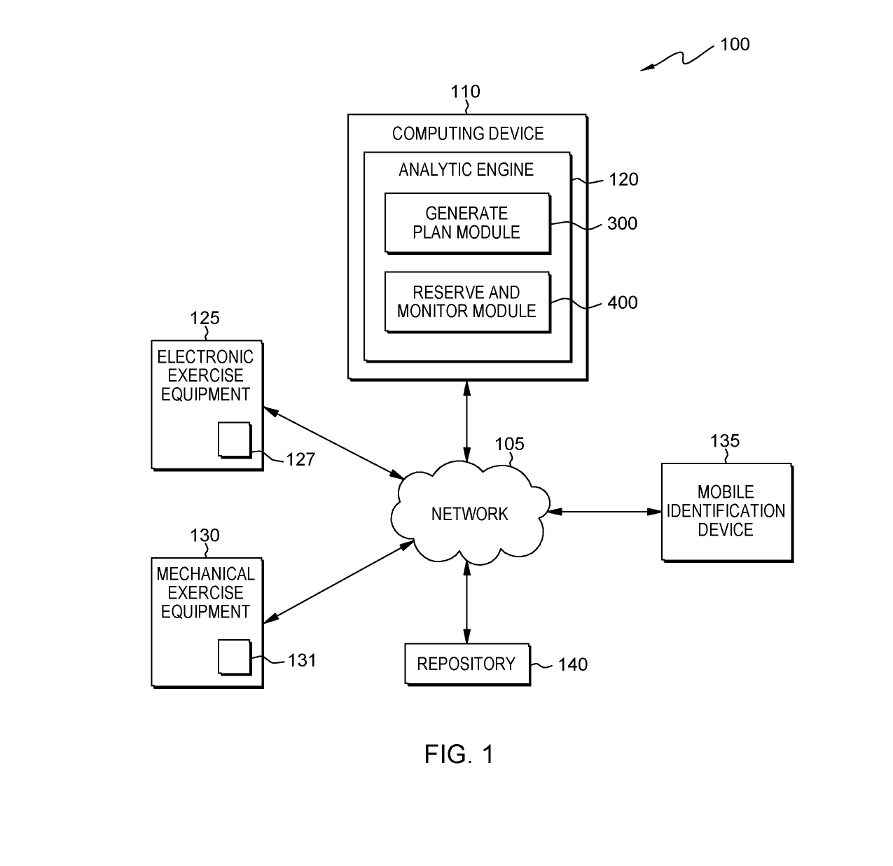

The present invention will now be described in detail with reference to the Figures. FIG. 1 is a functional block diagram illustrating a computer network system environment, generally designated as 100, in accordance with at least one embodiment of the present invention. FIG. 1 provides only an illustration of at least one implementation and does not imply any limitations with regard to the environments in which different embodiments may be implemented. Many modifications to the depicted environment may be made by those skilled in the art without departing from the scope of the invention as recited by the claims.

Computer network system environment 100 includes computing device 110, which is depicted as including analytic engine 120; electronic exercise equipment 125, mechanical exercise equipment 130, identification readers 127 and 131, mobile identification device 135, and repository 140, all interconnected via network 105. Identification readers 127 and 131 correspond respectively to electronic exercise equipment 125 and mechanical exercise equipment 130. Analytic engine 120 includes generate plan module 300 and reserve and monitor module 400.

Network 105 may be, in a non-limiting example, a local area network (LAN), a telecommunications network, a wide area network (WAN), such as the Internet, a virtual local area network (VLAN), a cable-broadcasting delivery network, a satellite broadcasting delivery network, or any combination of network types that can include wired, wireless, or optical connections. Network 105 can be any combination of connections and protocols that will support communications between computing device 110, which is shown hosting analytic engine 120, which further includes components generate plan module 300 and reserve and monitor module 400; and electronic exercise equipment 125, mechanical exercise equipment 130, identification readers 127 and 131, mobile identification device 135, and repository 140, in accordance with embodiments of the present invention.

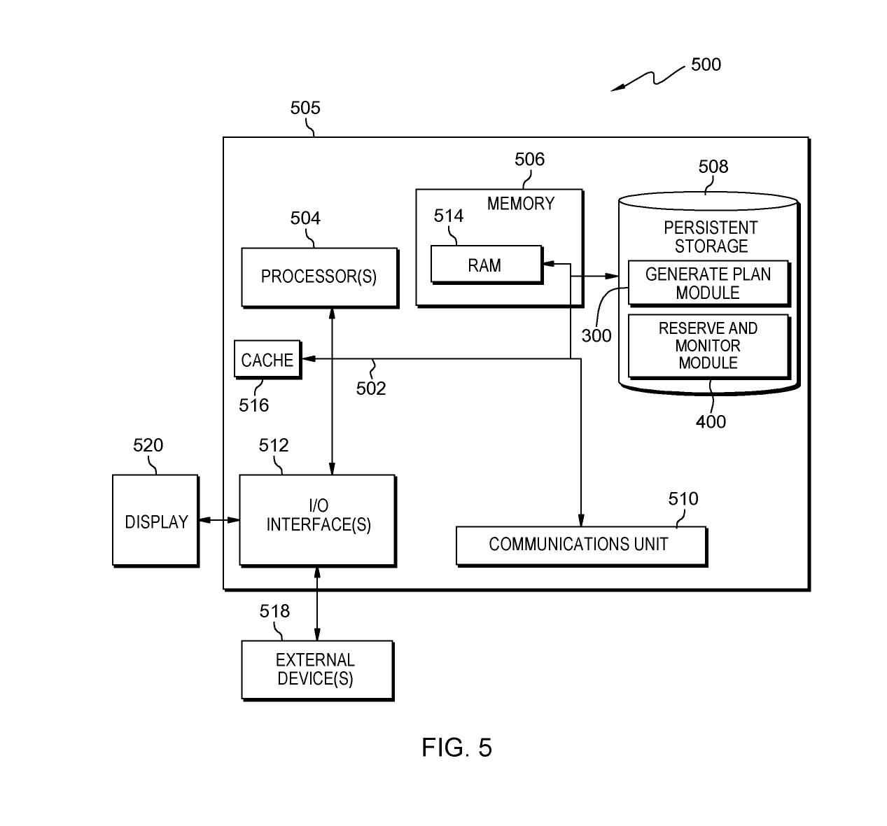

Computing device 110 is configured to host analytic engine 120, which includes generate plan module 300 and reserve and monitor module 400, and is configured to provide computer processing capability to perform the operations and functions of generate plan module 300 and reserve and monitor module 400. Computing device 110 can be a standalone computing device, a management server, a web server, a mobile computing device, or any other electronic device or computing system capable of receiving, sending, and processing data. In other embodiments, computing device 110 can represent a server computing system utilizing multiple computers as a server system, such as in a cloud computing environment. In another embodiment, computing device 110 can be a laptop computer, a tablet computer, a netbook computer, a personal computer (PC), a desktop computer, a personal digital assistant (PDA), a smart phone, or any other programmable electronic device capable of communicating with identification readers 127 and 131, and mobile identification device 135 via network 105. Computing device 110 may include internal and external hardware components, as depicted and described in further detail with respect to FIG. 5.

Analytic engine 120 includes software components generate plan module 300, and reserve and monitor module 400. Analytic engine 120, through execution of generate plan module 300 and reserve and monitor module 400, receives profile and goal input from members of a fitness center, receives member and exercise equipment identification and exercise equipment activity data, generates workout plans for members, taking into account member and exercise equipment availability, and recommends adjustments to member workout plans, based on member exercise equipment activity data. Hereafter, the activity and attributes of analytic engine 120 will be discussed with regards to the operational functions of generate plan module 300 and reserve and monitor module 400, respectively.

Generate plan module 300 receives workout profile and goal information from a fitness center member, generates a workout plan and schedule for the member, based on the received profile and goal information, and availability of the exercise equipment. In some embodiments of the present invention, generate plan module 300 produces a member workout plan that can be either accepted, rejected, or modified by the member. In the latter two instances where the member rejects or modifies the workout plan, embodiments of generate plan module 300 edit the workout plan, based on user preferences, profile parameters, exercise equipment availability, and additional input from the member. Generate plan module 300 initiates reserve and monitor module 400 to reserve the exercise equipment identified in the member's workout plan, in response to the member accepting the workout plan.

In some embodiments of the present invention, the member's profile information received by generate plan module 300, includes, for example, the member's current physical condition including body weight, height, waistline measurements, age, and gender. In some embodiments, the member's profile information includes the member's current medical condition(s), such as heart health information, injury information, and asthmatic conditions. Generate plan module 300 also receives member input regarding desired exercise and physical condition goals. In some embodiments, generate plan module 300 will prepare, based on the member's availability, preferences, and current and desired physical condition, a workout plan that creates a schedule of the various exercises, intensity levels, and durations recommended for the member to perform in order to achieve the desired physical condition. A schedule of the various exercises includes: (i) day-of-the-week for each session of the workout plan; (ii) a start time of each session of the workout plan; (iii) a duration of each exercise within the workout plan; (iv) a listing of exercise equipment utilized in each session of the workout plan; and (v) an order in which to utilize exercise equipment. In some embodiments, generate plan module 300 will factor in the member's current physical and medical condition(s), and will generate a workout plan that addresses the member's health related goals within the limitations of the member's current medical conditions. For example, if the member is overweight, has a known heart condition, and wishes to shed body weight, generate plan module 300 will generate a workout plan that will guide the member to achieve his fitness goal while not exacerbating the member's heart condition by adjusting the duration and intensity of the workout plan.

In some embodiments, generate plan module 300 may transmit a member's workout plan to mobile identification reader 135 which, if properly configured, outputs a display of the workout plan that can be viewed, and that allows the member to take action, such as accepting, rejecting, or modifying the workout plan. In other embodiments, generate plan module 300 may transmit the workout plan to a secure web page for the member to view on a computing device of the member's choice. In yet other embodiments, the workout plan can be received by the member in an email, or as an image file sent with a text message, allowing the member to utilize various electronic communication devices to access the workout plan.

Reserve and monitor module 400 receives information relating to the member's workout schedule from generate plan module 300, and reserves the use of a particular set of exercise equipment corresponding to the goals of the member, such as electronic exercise equipment 125 and/or mechanical exercise equipment 130. Reserve and monitor module 400 receives the members' workout data from the member's exercise activity performed on the reserved exercised equipment used during the member's workout, as well as the member's identification and the identification of the particular piece of exercise equipment. Reserve and monitor module 400 sends the member's workout data and updated profile information to generate plan module 300.

In some embodiments of the present invention, reserve and monitor module 400 is initiated by generate plan module 300, and receives the member's workout plan information from generate plan module 300 and begins the process of reserving the required exercise machines, such as electronic exercise equipment 125 and/or mechanical exercise equipment 130. Reserve and monitor module 400 determines whether a particular member has reserved the use of either electronic exercise equipment 125 or mechanical exercise equipment 130 by communicating, respectively, with identification readers 127 or 131. In some embodiments, reserve and monitor module 400 receives the member's monitored workout information and determines the member's progress with respect to the member's goals and objectives. Reserve and monitor module 400 aggregates and analyzes the monitored workout data of the member, and determines the progress made by the member. In some embodiments, reserve and monitor module 400 determines whether a defined threshold of improvement has been crossed towards the workout and goals, and if the threshold is crossed, reserve and monitor module 400 sends the analyzed workout data to generate plan module 300 to generate an updated workout plan. The original profile of the member may be updated to reflect various elements of progress, such as loss of weight, duration of exercise, and resistance levels used.

In some embodiments, reserve and monitor module 400 determines whether the exercise equipment reserved by the member was used by the member at the scheduled time. In some embodiments, reserve and monitor module 400 makes use of a queue, or waitlist, and reserves the use of certain exercise machines based on the order of the waitlist. For example, if a member reserves the use of an exercise machine but fails to utilize it at the scheduled time, then reserve and monitor module 400 reserves the use of the same machine for the member whose placement was one position below the reserving member. Additionally, for example, if a member wishes to use an unavailable machine two hours into the future, and such machine becomes available thirty minutes prior to the member's workout, reserve and monitor module 400 checks to see if other members have requested use of the exercise machine, and sends an alert to such person(s) that the exercise machine is available. In some embodiments, reserve and monitor module 400 alerts such members on a first come first served manner, and reserve and monitor module 400 alerts only those users who can make use of the machine in a certain window of time, such as a thirty-minute window.

In some embodiments, reserve and monitor module 400 receives the member's workout activity data from a device operationally connected to electronic exercise equipment 125 and/or mechanical exercise equipment 130, such as identification readers 127 and/or 131, which have been configured to transmit data. In other embodiments, reserve and monitor module 400 receives the member's workout activity data directly from electronic exercise equipment 125, or from an additional device operationally connected to the exercise equipment (not shown), which is configured to receive identification information of the member, from identification readers 127 and 131, and identification of the respective piece of exercise equipment. Reserve and monitor module 400 sends the accumulated and analyzed workout data to generate plan module 300, thereby creating an iterative process of receiving and analyzing the member's workout data.

Mobile identification device 135 can be one of various devices that are portable in nature, and can communicate with an identification and activity tracking device(s) connected to electronic exercise equipment 125 and mechanical exercise equipment 130, for example. Mobile identification device 135 may be, for example, a cellular telecommunications device, such as a smart phone, a Radio Frequency Identification (RFID) transmitting device, a smart watch, or other device that can indicate a member's identity at close proximity. Mobile identification device 135 communicates with identification readers corresponding to respective exercise equipment of the fitness center, such as identification readers 127 and 131, which correspond to electronic exercise equipment 125 and mechanical exercise equipment 130, respectively.

In some embodiments of the present invention, Mobile identification device 135, is a wearable device, such as a bracelet, clip-on, or other device attachable to the member or members clothing or shoes. Mobile identification device 135 transmits a member's identification and, if properly configured, may receive data by use of various transmission technologies, such as (RFID), Wi-Fi, Bluetooth® (BLUETOOTH is a registered trademark of Bluetooth Special Interest Group (SIG) in the U.S. and in other countries worldwide), near field communication (NFC), telecommunication channels, light waves, or sound waves. Mobile identification device 135 provides identification of a fitness center member to identification readers 127 and 131 corresponding to fitness center exercise equipment. The connection between mobile identification device 135 and identification reader 127 of electronic exercise equipment 125, or identification reader 131 of mechanical exercise equipment 130, associates the identity of the member with scheduling and use of particular pieces of exercise equipment of the fitness center. In some embodiments of the present invention, mobile identification device 135, if properly configured, receives information from both generate plan module 300 and reserve and monitor module 400. Information received from generate plan module 300 may include notifications regarding the workout plan and schedule for the member to perform, the sequence of use of the exercise equipment as designated by the workout plan and schedule, and notifications if a particular piece of exercise equipment is unexpectedly available or not available. Mobile identification device 135, if properly configured, may receive progress indicators of the member's workout performance and progress towards goals. In other embodiments, mobile identification device 135 is configured to enable a member to schedule or reserve use of a particular piece of exercise equipment, interacting with either or both of generate plan module 300 and reserve and monitor module 400. The range in which mobile identification device 135 may transmit and receive data associated with the fitness center may be limited by the specific type and capability of the device.

In some embodiments, mobile identification device 135 can transmit member reservation data specifying whether or not the member has reserved the use of either electronic exercise equipment 125 or mechanical exercise equipment 130 at a particular time and for a pre-defined period of time. Mobile identification device 135, in some embodiments, can display, or transmit to a computing device capable of displaying, the member's workout information that was calculated by reserve and monitor module 400 with respect to the duration of the workout, relevant metrics, such as distance ran, amount of weight lifted, number of repetitions conducted per exercise, calories burned, and whether the user rested during any point of the workout.

Identification readers 127 and 131 can be one of a variety of RFID systems, including Passive Reader Active Tag (PRAT), Active Reader Passive Tag (ARPT), Active Reader Active Tag (ARAT), for example, or other types and technologies of electronic receivers. Identification readers 127 and 131 correspond, respectively, to electronic exercise equipment 125 and mechanical exercise equipment 130. In some embodiments, identification readers 127 and 131 receive identification of the member from mobile identification device 135, and determine whether the member is scheduled to use electronic exercise equipment 125 or mechanical exercise equipment 130. In some embodiments, identification readers 127 and 131 may receive identification data, if the member is within a pre-determined distance of identifications reader 127 and/or 131.

Electronic exercise equipment 125 is a piece of equipment on which a member performs physical fitness activities, and utilizes an electric power source to operate. Electronic exercise equipment 125 may include, for example, treadmills, elliptical cross-trainers, stationary bikes, and stepper machines. Electronic exercise equipment 125 further includes identification reader 127 that is operationally connected to electronic exercise equipment 125, and receives identification data of a member in close proximity to electronic exercise equipment 125, from mobile identification device 135. Further, electronic exercise equipment 125 is communicatively connected to computing device 110, where the data generated on electronic exercise equipment 125 is transmitted to computing device 110.

In some embodiments, electronic exercise equipment 125 transmits the data associated with the member's exercise routine to reserve and monitor module 400, which analyzes the data. For example, the data transmitted can include analytic metrics regarding the member's workout, such as estimated calories burned, distance covered, or amount of repetitions performed, and can provide the member with real-time feedback as to the member's current progress toward the original goals and objectives.

In some embodiments of the present invention, identification reader 127 receives the data generated by the member's activity while using electronic exercise equipment 125, and transmits the data associated with electronic exercise equipment 125, and the identity of the particular member using electronic exercise equipment 125, as well as the identity of electronic exercise equipment 125, to reserve and monitor module 400, hosted on computing device 110.

In some embodiments of the present invention, a member that wants to use electronic exercise equipment 125 can reserve use of electronic exercise equipment 125 in advance, if available. In some embodiments, if the member reserved use of electronic exercise equipment 125 and comes within a pre-determined distance of electronic exercise equipment 125, then electronic exercise equipment 125 will recognize the member when identification reader 127 of electronic exercise equipment 125, receives the member's unique identifying signal from mobile identification device 135. In other embodiments, mobile identification device 135 may be a smart card, and the member's identification is determined by the member swiping the smart card or placing the smart card in the proximity of identification reader 127.

If the member reserved the use of electronic exercise equipment 125 at a particular time, and fails to utilize electronic exercise equipment 125 within a pre-determined period of time of the scheduled use start time, another member may be notified of the availability of electronic exercise equipment 125. In some embodiments of the present invention, the available electronic exercise equipment 125 will recognize the member having reserved the equipment, within a pre-determined period of time of the next reservation of the equipment. In some embodiments, if the original member attempts to utilize electronic exercise equipment 125 after a pre-determined period of time from the scheduled use start time, identification reader 127 will not recognize the member's reservation of the equipment, and the member may receive a notification of an expired attendance window-of-time on mobile identification device 135, if so configured, or on an electronic display communicatively coupled to electronic exercise equipment 125. In some embodiments, the use of electronic exercise equipment 125 can be limited in terms of duration and intensity based on the information included in the member's current physical condition information and medical information. For example, if the member has a known heart condition, a treadmill may prevent the member from exceeding usage of a certain period of time, or from exceeding a certain speed within a given period of time.

Mechanical exercise equipment 130 is a piece of exercise equipment that does not use an electrical power source, and on which a member performs physical fitness exercises. Mechanical exercise equipment 130 may be, for example, leg press machines, bicep curl machines, ab crunch machines, and butterfly machines, in which a member pushes or pulls against resistance for physical activity. Mechanical exercise equipment 130 includes identification reader 131, which is operationally connected to, and communicates with, mobile identification device 135 in order to identify the member accessing mechanical exercise equipment 130. In some embodiments mechanical exercise equipment 130 is communicatively connected to reserve and monitor module 400 to provide data associated with an identified member's activity on identified mechanical exercise equipment 130. For example, identification reader 131 is operationally connected to mechanical exercise equipment 130, and configured to receive and transmit the member's identification, the equipment identification, and the member's workout activity data to reserve and monitor module 400.

In some embodiments of the present invention, the member's workout activity data is analyzed by reserve and monitor module 400, and a summary of the member's workout data is made available for the member to view, in order to provide feedback. In some embodiments, the summary of the workout is transmitted to mobile identification device 135, if so configured. In other embodiments, the member obtains analyzed workout feedback by accessing data sent to a secure website, sent in an email, or sent in an image via text message, for example. Providing feedback to a member may occur subsequent to each use of exercise machine, or subsequent to use of a sequence of multiple exercise machines. In other embodiments, the feedback may be provided within a pre-determined time period, for example, weekly.

In some embodiments of the present invention, identification of a member in close proximity to identification reader 131, operationally connected to mechanical exercise equipment 130, operates similar to that of electronic exercise equipment 125 and identification reader 127, described above. Additionally, aspects of a member failing to use or arriving late to reserved mechanical exercise equipment 130, are similar to those described above for electronic exercise equipment 130.

In some embodiments, if the member reserved use of mechanical exercise equipment 130 and comes within a pre-determined distance of mechanical exercise equipment 130, then mechanical exercise equipment 130 will recognize the member when identification reader 131 of mechanical exercise equipment 130 receives the member's unique identifying signal from mobile identification device 135. If the member reserved the use of mechanical exercise equipment 130 at a particular time, and fails to utilize mechanical exercise equipment 130 within a pre-determined period of time of the scheduled use start time, another member may be notified of the availability of mechanic exercise equipment 130. In some embodiments of the present invention, the available mechanical exercise equipment 130 will recognize the member having reserved the equipment within a pre-determined period of time of the next reservation of the equipment. In other embodiments if the original member attempts to utilize mechanical exercise equipment 130 after a pre-determined period of time from the schedule use start time, identification reader 131 will not recognize the member's reservation of the equipment, and the member may receive a notification of an expired attendance window on mobile identification device 135, if so configured. In some embodiments, the use of mechanical exercise equipment 130 can be limited, in terms of duration and intensity, based on the information included in the member's current physical condition information and medical information. For example, a set of leg curls could limit the amount of weight and the repetitions that the member can perform. Once the member performs the maximum number of leg curls, the leg curl machine could, in some embodiments, automatically lock, thereby preventing the member from performing additional repetitions.

Repository 140 is a data storage medium that is operationally connected to generate plan module 300 and reserve and monitor module 400 via network 105. In some embodiments, repository 140 includes various types of storage mediums, such as a database, a database server, an online data storage medium, a digital file system, a physical file system, and a warehouse. In some embodiments, repository 140 is used to accumulate and store data generated by generate plan module 300 and reserve and monitor module 400. In some embodiments, repository 140 can store one or more fitness center members' profile, which is accessible to the member as well as generate plan module 300 and reserve and monitor module 400.

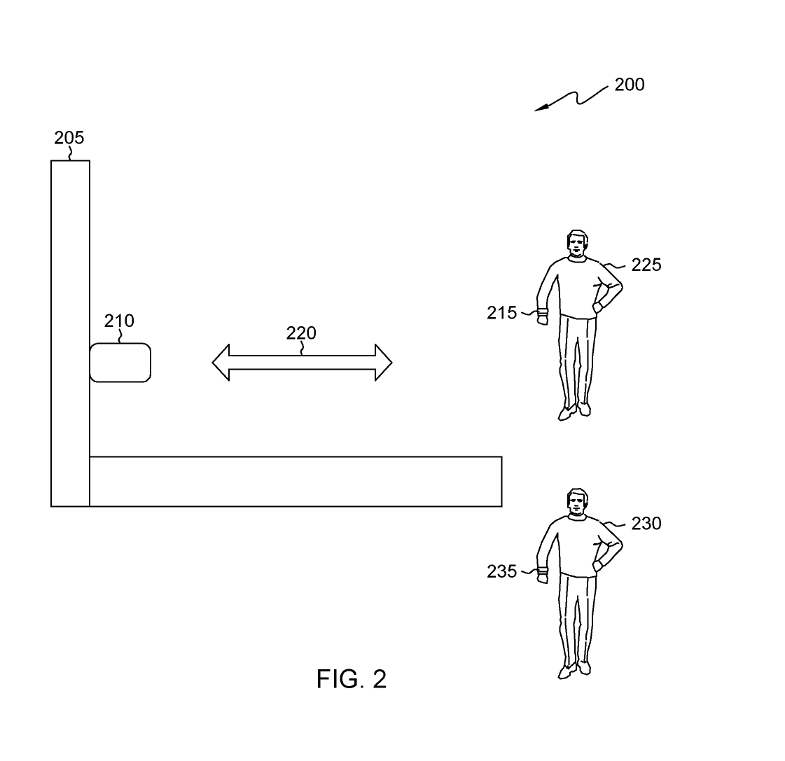

FIG. 2 illustrates a portion of exemplary fitness center 200, which includes members 225 and 230 interacting with exercise equipment 205, in accordance with an embodiment of the present invention. Exemplary fitness center 200 includes exercise equipment 205, identification reader 210, mobile identification devices 215 and 235, data 220, and members 225 and 230. Mobile identification device 215 corresponds to member 225 and mobile identification device 235 corresponds to user 230.

In embodiments of the present invention, exercise equipment 205 may correspond to a piece of exercise equipment, such as electronic exercise equipment 125 (FIG. 1), or mechanical exercise equipment 130. Exercise equipment 205 contains identification reader 210, which receives identification data from mobile identification device 215 and/or mobile identification device 235 when either member 225 or 230 is within a pre-determined distance to exercise equipment 205.

Data 220 can be in a type of format that identification readers 210 and 235 can receive and recognize, including various types of radio frequencies and electronic data. Data 220 is communicated between mobile identification devices 215 or 235 and identification reader 210. In some embodiments, member 225 or 230 can come within a pre-determined distance of identification reader 210, and identification information contained in data 220 from mobile identification device 215 or 235 can be communicated to identification reader 210.

The information contained in data 220 identifies member 225 who is within a pre-determined distance to exercise equipment 205. Data 220 is transmitted from mobile identification device 215 to identification reader 210, and the identification of member 225 and exercise equipment 205 is communicated to reserve and monitor module 400. In some embodiments, exercise equipment 205 receives identification information of a member and transmits the member identification and exercise equipment identification to reserve and monitor module 400. In other embodiments, alternatively, identification reader 210 transmits the member identification information and exercise equipment information to reserve and monitor module 400.

Identification reader 210 receives data 220 from mobile identification device 215 or mobile identification device 235, based on their respective proximity to identification reader 210. In some embodiments of the present invention, identification reader 210 communicates the identification information contained in data 220 to exercise equipment 205, which in turn communicates the identification information and data associated with member 225's workout on exercise equipment 205 to reserve and monitor module 400. In other embodiments, identification reader 210 communicates the identity of member 225 and exercise equipment 205 to reserve and monitor module 400, and may also provide the data associated with the workout performed by member 225 on exercise equipment 205.

Mobile identification devices 215 and 235 may be one of various devices that are portable in nature, and identifies a member to an identification reader, such as identification readers 127 or 131, connected to electronic and mechanical exercise equipment of the fitness center, as described above with regard to mobile identification device 135. In some embodiments, mobile identification devices 215 and 235 may be a card or badge that determines a member's identity from the member inserting, swiping or placing the card or badge in vicinity of identification reader 210.

In some embodiments of the present invention, mobile identification devices 215 and 235 transmit identification data to identification reader 210 in order to determine the identity of members 225 or 230, respectively. In some embodiments, if member 225 has reserved the use of exercise equipment 205, and member 225 comes within a pre-determined distance of exercise equipment 205, mobile identification device 215 may transmit data 220, which identifies member 225, to reserve and monitor module 400, which determines that member 225 has reserved the use of exercise equipment 205. In some embodiments, if member 230 has not reserved the use of exercise equipment 205, and member 230 comes within a pre-determined distance of exercise equipment 205, mobile identification device 235 may transmit data 220 relating to identification information of member 230, and member 230 will not be identified as the member who has reserved the use of exercise equipment 205.

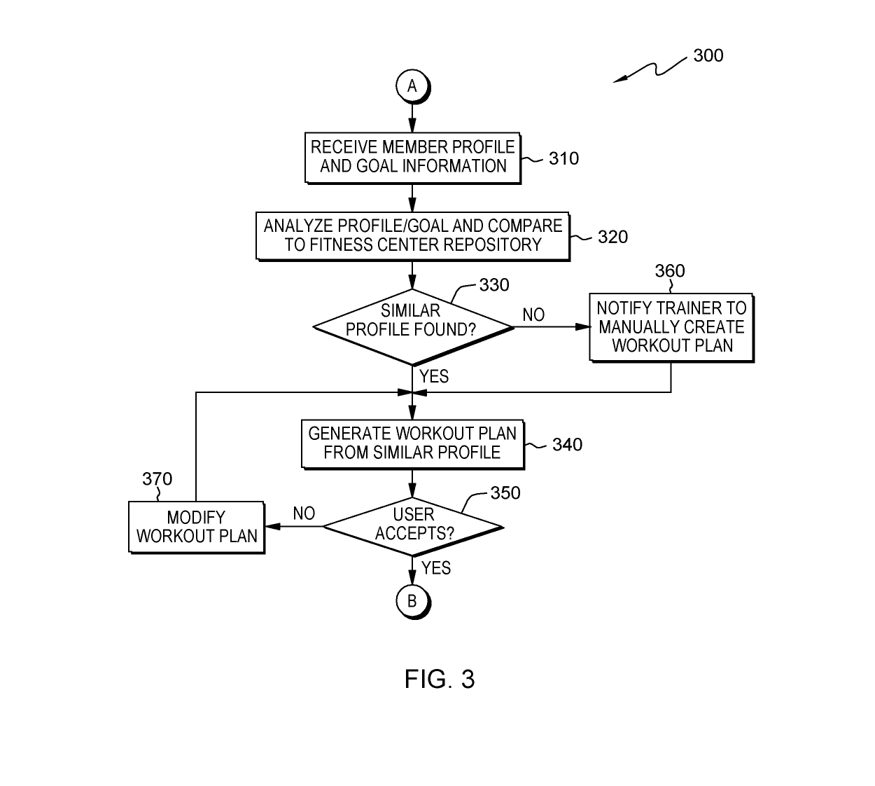

FIG. 3 is a flowchart illustrating operational steps of generate plan module 300 within computer network system environment 100 of FIG. 1, for determining a workout plan, in accordance with an embodiment of the present invention.

In step 310, generate plan module 300 is initiated at “A,” and receives an input including a member's profile information, and exercise goals and objectives. In some embodiments of the present invention, the member may input information describing the member's current physical condition, such as height, weight, waist size, body mass index, age, and gender. In some embodiments, the member may input information describing the member's current health conditions, such as heart health, injuries, and asthmatic conditions. The member may also input information describing desired fitness goals and objectives, such as losing a certain amount of weight, gaining a certain amount of weight, or generally feeling healthier. In some embodiments, the member may input information describing logistical goals and objectives, such as the time frame in which to realize the desired fitness goals and objectives, and the frequency in which the member can conduct the required exercise routines. Generate plan module 300 receives input from the member that includes preferences and limitations of the member's scheduling availability. Generate plan module 300 generates the member's profile, based on the input of information received from the member.

In step 320, generate plan module 300 analyzes the member profile information and compares the member's profile against a fitness center repository, such as repository 140, containing profiles of other fitness center members to find a set of profile and goal information similar to the generated member profile. In some embodiments, if a profile is generated for a member, referred to hereafter as a current member for clarity purposes, who inputs profile information, such as height, current weight, desired weight, and time frame in order to achieve a desired physical condition goal, the profile and goal information of the current member is then compared against other member profiles in order to find either an exact match, or a similar match, such as a near-match. In some embodiments, step 320 compares the current member's profile and goal information to profile and goal information of other fitness center members, where “other” or “another” member(s) may include past or present fitness center member(s) that are not the “current” member.

In some embodiments of the present invention, a similarity function is used to determine a degree, or confidence level of similarity in determining a match between profile and goal information of the current member and profile and goal information of previous members whose profile and goal information is included in a repository accessible by generate plan module 300. In some embodiments, the similarity function used may be a cosine similarity function that assigns vectors and values to elements of profile and goal information, and determines a score reflecting a degree of similarity.

In decision step 330, generate plan module 300 determines whether the degree of similarity between the current member's profile and goal information and another member's previously established profile and goal information. In some embodiments, for example, a highly similar, set of profile and goal information from another fitness center member is a profile that is either an exact match or a satisfactorily similar to the current member's profile and goal information, in which a satisfactorily similar match is confirmed by acceptance of the new generated workout plan by the current member.

In the case in which generate plan module 300 determines that the current member profile and goal information is a match or near-match, similar to another member's profile and goal information stored in a local repository of fitness center member profiles (step 330, “YES” branch), generate plan module 300 proceeds to step 340.

In step 340, generate plan module 300 generates a workout plan for the current member. In some embodiments, generate plan module 300 generates a workout plan for the current member by matching, to a high degree of similarity, the current member's profile and goal information to that of another member's profile and goal information, previously generated and stored in a repository. For example, if the current member's goals and objectives are to lose a fixed amount of weight within a particular period of time, generate plan module 300 creates a workout plan based on a previous workout plan that helped another member having a similar profile lose approximately the same amount of weight within approximately the same period of time.

In other embodiments of the present invention, generate plan module 300 can access a repository of known sources of profile and workout goal information, referred to hereafter as “known workouts” or “known workout information” for brevity, in order to find attributes and goal information comparable to the current member profile. Known workouts include accessible profile and goal information of people that are stored in repositories external to the fitness center. Generate plan module 300 accesses and compares the current member's profile and goal information to the attributes and goal information stored in a repository of known workout information, which includes the profile and goal information of a plurality of people. In one embodiment, known workout information includes online fitness content describing the profile information, physical condition, and goal objectives of at least one person, and the exercise regimen followed by the at least one person to achieve or progress towards their stated fitness goal. For example, a fitness website displaying profiles of a group of people who have volunteered information on how they went from their former physical condition to their current physical condition, including their accompanying workout plan and schedule, may constitute known workout information. In some embodiments, for example, the current member's profile and goal information can be compared against a database of profiles uploaded onto various fitness websites, or a database containing general recommended workouts that have traditionally yielded the results matching the current member's goals and objectives.

For the case in which profile and goal information similar to that of the current member is not found in the external repository of profile and goal information (step 330, “NO” branch), generate plan module 300 proceeds to step 360, and notifies an agent of the fitness center, such as a trainer, to intercede in generating a workout plan for the current member. Once the trainer generates a workout plan for the current member, generate plan module 300 proceeds to decision step 350. In some embodiments, generate plan module 300 notifies a trainer of the fitness center that a match of similar profile and goal information was not found. In some embodiments, the trainer meets with the current member to create a workout plan based on the current member's input, the current member's profile and the trainer's personal knowledge of fitness and health. For example, if the current member meets with the trainer, and the trainer generates a workout plan for the current member that is not acceptable to the current member, the current member and the trainer can iteratively work to create a workout plan that is acceptable to the current member.

In decision step 350, generate plan module 300 determines whether the current member accepts or rejects the workout plan generated in step 340. In the case in which generate plan module 300 determines that the current member accepts the generated workout plan without modification (step 350, “YES” branch), generate plan module 300 proceeds to “B”, thereby initiating reserve and monitor module 400, and terminating generate plan module 300. For the case in which generate plan module 300 determines that the current member rejects the generated workout plan (step 350, “NO” branch), generate plan module 300 proceeds to step 370 in which generate plan module 300 modifies the generated workout plan for the current member. For example, if the current member considers certain exercises to be too difficult, the current member can reject the plan, thereby allowing the current member to assess and reassess the recommendations of a generated workout plan against the current member's goals and objectives, and in some embodiments, the current member provides additional input towards an acceptable workout plan.

In step 370, generate plan module 300 modifies the generated workout plan rejected by the current member. In some embodiments, the current member can reject the generated workout plan either entirely or partially, and can indicate which portions of the generated workout plan the current member objects to. In some embodiments, the current member may find that the generated workout plan may be more rigorous than expected, and the current member may make the necessary alterations in order to adjust the level of rigor by rejecting the generated workout plan. For example, if the current member has a goal of losing a pre-defined amount of weight, and the generated workout plan requires that the current member run a minimum of five miles per day on a treadmill machine, then the current member can reject this plan and opt to run a minimum of one mile per day on a treadmill machine.

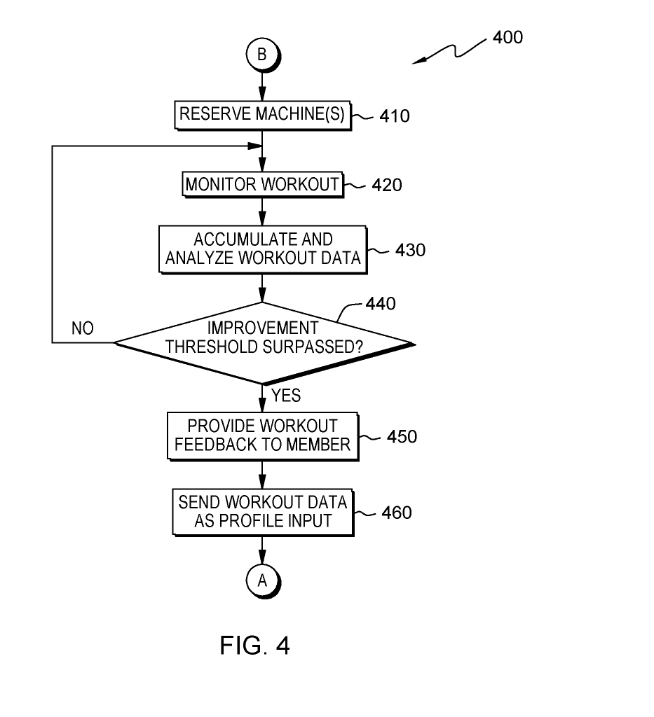

FIG. 4 is a flowchart illustrating operational steps of reserve and monitor module 400 within computer network system environment 100 of FIG. 1, for reserving and monitoring a workout schedule, in accordance with an embodiment of the present invention.

Reserve and monitor module 400 is initiated by generate plan module 300 at “B”, in response to the current member accepting the generated workout plan. In step 410, reserve and monitor module 400 receives the accepted workout plan for the current member, and reserves the exercise machines scheduled for use by the current member according to the accepted workout plan. In some embodiments of the present invention, reserve and monitor module 400 reserves the exercise machine(s) identified as available from the accepted workout plan. Reserve and monitor module 400 determines the availability of exercise equipment and iteratively interacts with generate plan module 300 until a workout plan consistent with the current member's availability and preferences is generated by generate plan module 300. For example, if the current member receives a workout schedule based on the generated workout plan, reserve and monitor module 400 will only identify and confirm that the particular reserving member may utilize the required exercise machine(s) at the times provided for in the workout schedule.

In step 420, reserve and monitor module 400 monitors the member's workout. Reserve and monitor module 400 receives workout data from the current member's workout, which may include duration, intensity, resistance, and repetition information associated with the exercise activity. In some embodiments of the present invention, reserve and monitor module 400 determines s whether the member's workout activity aligns with the particular workout recommended by the generated workout plan by comparing the received workout data to the planned workout activity. For example, if the current member's generated workout plan includes running on the treadmill for thirty minutes and then performing weight lifting exercises for an additional thirty minutes between the hours of 3:00 PM and 4:00 PM every Thursday, reserve and monitor module 400 determines whether the current member performed aspects of the generated workout plan.

In step 430, reserve and monitor module 400 accumulates and analyzes the current member's workout data. In some embodiments of the present invention, reserve and monitor module 400 receives information generated from the current member's workout and analyzes the received information. In some embodiments, reserve and monitor module 400 analyzes the received information by evaluating the current member's workout duration, intensity, and consistency, for example. In other embodiments, reserve and monitor module 400 can compartmentalize data generated from various workouts in accordance with the day of the week, workout type (e.g. cardiovascular workouts, upper body strength training, lower body strength training), or any combination of the workout types conducted. For example, if the current member has a workout schedule with a mixed cardiovascular and strength training regiment, then reserve and monitor module 400 can evaluate the quality of the workout, in terms of calories burned or repetitions performed, and can determine whether or not the workouts are conducted in a manner that most efficiently optimizes the current member's time and the workouts required to achieve the current member's goals and objectives based on real-time feedback from each individual workout.

In decision step 440, reserve and monitor module 400 determines whether an improvement threshold for determining the member's progress towards achieving the current member's goals and objectives is surpassed. In the case in which generate plan module 400 determines that the current member has surpassed the improvement threshold (step 440, “YES” branch), reserve and monitor module 400 proceeds to step 450 and provides feedback to the current member. In some embodiments, the improvement threshold in reserve and monitor module 400 is predetermined. For example, reserve and monitor module 400 uses standardized metrics of improvement and/or input by the current member to determine the improvement threshold.

In some embodiments, reserve and monitor module 400 determines whether the improvement threshold has been exceeded by comparing the overall quality and quantity of the member's workout progression to the expected workout progression. In some embodiments, the improvement threshold will be defined such that it may require multiple workouts to exceed. In some embodiments, progress can be tracked by looking to a difference in a certain amount of weight lifted, repetitions performed, or time required to cover a certain distance. For example, if the member originally ran one mile on a treadmill in twenty minutes, and is currently running one mile on a treadmill in fifteen minutes, the difference in time spent running may suffice to surpass the improvement threshold.

In step 450, reserve and monitor module 400 provides workout feedback to the current member. In some embodiments of the present invention, reserve and monitor module 400 assembles the accumulated and analyzed data in a summarized format. Workout feedback includes, for example, time spent, calories burned, and heart rate. In some embodiments, reserve and monitor module 400 will display the accumulated and analyzed data in the form of a graph or a chart, the parameters of which may be manipulated. In some embodiments, reserve and monitor module 400 may provide workout feedback that can be viewed on the current member's mobile device or home computing device, in the form of an email, text message, image file, or other compatible files.

In step 460, reserve and monitor module 400 sends analyzed workout data to generate plan module 300. In some embodiments of the present invention, having determined that the improvement threshold has been exceeded and providing workout data feedback to the current member, reserve and monitor module 400 proceeds to “A”, initiating generate plan module 300. Reserve and monitor module 400 sends the analyzed workout data to generate plan module 300, initiating module 300 to update the current member's profile and goal information, and proceed to generate an updated workout plan, as described above in regard to FIG. 3. In response to proceeding to “A” to send the analyzed workout data to generate plan module 300, reserve and monitor module 400 ends.

In some embodiments, reserve and monitor module 400 receives monitored workout information from the current member over multiple workout sessions and determines progress towards the goals and objectives. For example, reserve and monitor module 400 may receive information that the current member is completing a particular workout at a greater intensity, higher number of repetitions, or for a shorter duration, along with the heart rate associated with a particular use of exercise equipment and workout plan. Having received the above information, reserve and monitor module 400 incorporates this information into the analyzed data of the current member's workout, and sends the data as input to generate plan module 300, which generates an updated workout plan for the member, thereby providing a way for the current member to continue progress towards goals. Alternatively, reserve and monitor module 400 may receive information that the current member is unable to perform the necessary workouts, and can update the current member's profile to reflect this information, thereby allowing the current member to receive an updated workout plan that will allow the member to more realistically work towards the current member's original goals and objectives.

Returning to the case in which reserve and monitor module 400 determines that the improvement threshold has not been surpassed (step 440, “NO” branch), reserve and monitor module 400 reverts to step 420 in which reserve and monitor module 400 monitors the current member's workouts, and proceeds as described above. In some embodiments, where the current member is unable to surpass the improvement threshold, the current member continues to perform the same workout. For example, if the improvement threshold is defined to require the current member to run a particular distance at a particular rate of speed, and the current member has been unsuccessful in doing so, the member continues to perform the current running exercise as indicated in the workout plan of the current member.

Some embodiments of the present invention address the following problems, and may include various combinations of function, attributes, and further details discussed below:

Most fitness centers are equipped with various exercise equipment, also referred to as “exercise machines” or “machines,” to serve wide customer needs. Many pieces of exercise equipment are limited in use due to the available space, popular demand, and financial resources of the company managing the fitness center. Even with an optimum amount of exercise equipment, during rush hours the usage can be overwhelming and some customers, also referred to herein as members, or users, will have to either wait, use a different type of exercise equipment, or come back to the fitness center at different time. This scenario is inconvenient to many fitness center users when the right equipment is not available for the intended workout. In some cases, exercise machine scheduling may require manual intervention.

This problem can be solved by computerizing the fitness center and connecting each piece of exercise equipment to the central computer network. Each piece of exercise equipment can have a sensor that sends data to central computer system when a user is identified and uses an exercise machine. An application (App), operating on the fitness center computer keeps track of each exercise machine in use, the identity of who uses the exercise machine, and for how long a user, or member uses the exercise machine, and may also monitor and collect additional data during performance of a workout plan by a fitness center member. Members interested in using certain workout equipment may make use of the App to reserve available exercise equipment via Fitness center computer system.

In addition to the computer system and sensors, a corresponding App for a smart device (smart phone or smart watch or tablet or computer) is included, with which a customer (member) can see the next available slot on any exercise machine and reserve it before even reaching to the fitness center. The process begins with setting up a user profile and goal information. A user logs in and is identified, receiving a confirmation of the reservation at the fitness center in order to avoid the practice of reserving, but not using the exercise equipment. If a reservation does not get confirmed or the exercise machine sits idle (no show), then persons who have made later reservations for the exercise machine are notified (via a smart device) of the availability, and can opt to take that spot. The application monitors reservation and usage of exercise equipment for repeated “no show” offenders, and may not allow the frequently repeated offenders to remotely make advance reservations during rush hours. The fitness center employees can override the reservations and scheduled machine usage and conflicts. The App on a smart device allows a user to Track Real-time machine availability and request a machine time, and Analytics helps to optimize the usage of the exercise equipment.

An analytic engine, which includes modules to generate workout plans, reserve exercise equipment, monitor exercise performance and monitor equipment usage, of the central computer system will look for similar profile and goal information from other previously established (members) users, and generate an Initial Fitness-program, or workout plan. Based on the workout plan, the analytic engine creates a schedule. A user can either accept the workout plan and schedule or make changes, and this information gets sent back to the analytic engine for on-going monitoring. The analytic engine monitors the Fitness-program and recommends changes with new scheduling when necessary.

The analytic engine helps to create customized fitness program and schedule. Analytics built into the analytic engine monitor and provide an adjusted new workout plan and schedule based on usage of exercise equipment and the user's goals. A user may have missed some days or used one machine more than another for various reasons, and this may require adjusting the new schedule. In the event where a machine becomes unavailable (e.g. the machine breaks down), Analytics recommends a machine that falls within the same type of exercise (for example ‘cardio’-type, or ‘weight bearing’-type).

A smart device is notified if a machine time becomes available. The App allows a member (user, customer), to schedule and reserve equipment-time in real-time. The smart device helps to make a connection to an exercise equipment's' sensors and identifies the member and the exercise equipment, and may transmit data to the central computer that includes the machine usage. Periodically, the analytic engine provides the user with a progress report and recommendations to improve the fitness of the member and stay on track to achieve member goals, based on workout activity performed by the user, and the analytic engine provides recommendations to enhance fitness center performance, equipment utilization, and possible future equipment requirements. In some embodiments of the present invention, a user can upload workout progress reports to social media to share with others.

Embodiments of the present invention include some or all of the following: (i) automate the scheduling a workout plan according to the user preference, usage patterns and availability of machine time; (ii) use smart device to allow user to pick computer generated schedule; (iii) track Real-time machine availability and schedule; (iv) allow user to select his/her own schedule; (v) optimize the usage of machines; and (vi) enhance and increase the efficiency of equipment and fitness center.

Embodiments of the present invention have the following advantages: (i) automate and customize scheduling a workout plan based on a usage pattern of a user, user's preference and availability of equipment; (ii) allow the user to schedule in advance; (iii) use a smart device (Phone, watch, tablet, etc.) to interface with a computer system, view, and schedule a workout plan while on the go; (iv) use a smart device (watch, wearable device) to register use of an exercise machine while at a fitness center; (v) use the collected data from the user's workout, and provide feedback and suggestions to the user; (vi) use the collected data to improve fitness center equipment requirements, (i.e. invest in the proper equipment); (vii) generate a physical activity report at certain interval for user analysis and necessary action; (viii) upload a physical activity report to social media in order to share with friends and family; and (ix) optimize equipment usage.

Embodiments of the present invention further aim to connect all exercise machines within a fitness center to a central computer system, which allows the central computer system to log the usage of each equipment and who is using the equipment in real-time. When a user uses the equipment, the user gets connected with the exercise equipment via either a RFID key for direct communication, a wearable or other device, using a wireless connection such as Bluetooth® or Wi-Fi. The App operating on the computer system tracks the usage of each piece of exercise equipment, the performance data of the user, and the usage pattern of the user.

An application program, or App, for a smart device is also developed to access the real-time schedule of the fitness center computer system. During peak usage of the fitness center, the central computer system provides multiple options to the user, including: (a) allowing the user to make their own decisions based on currently free exercise equipment; (b) automating a workout schedule based on a particular user's usage pattern and availability of equipment; (c) allowing users to interact and provide their choice of exercise equipment, and generate a new workout schedule, while provide all possible available options to choose.

Embodiments of the present invention enable interaction with the App on the central computer system to setup the schedule well in advance. Upon availability of the exercise equipment, a computer system sends a signal/SMS to a particular registered device in order to inform interested users that exercise equipment is available. A user can then either accept the time slot provided, and reserve for use of the exercise equipment, or reject the message and may request a new time slot in which to use the exercise equipment. Flexible workout scheduling informs a user that no one is waiting to use the exercise equipment and use of the exercise equipment can be continue.

FIG. 5 depicts a block diagram of components of system 500, including computing device 505, capable of operationally performing generate plan module 300 and reserve and monitor module 400, in accordance with an embodiment of the present invention.

Computing device 505 includes components and functional capability similar to computing device 110 (FIG. 1), in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 505 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506, cache memory 516, and persistent storage 508 are computer readable storage media. In this embodiment, memory 506 includes random access memory (RAM) 514. In general, memory 506 can include any suitable volatile or non-volatile computer readable storage media.

Generate plan module 300 and reserve and monitor module 400 are is stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of computer network system environment 100. In these examples, communications unit 510 includes one or more network interface cards. Communications unit 510 may provide communications through the use of either or both physical and wireless communications links. Generate plan module 300 and reserve and monitor module 400 may be downloaded to persistent storage 508 through communications unit 510.

I/O interface(s) 512 allows for input and output of data with other devices that may be connected to computing system 500. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., [generate plan module 300 and reserve and monitor module 400], can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

“Exercise resource of a common type”: means that that the exercise resources are considered to be interchangeable for scheduling and exercise purposes. This interchangeability may vary with the larger context. For example, Gym A may decide that stair climbing machines made by Manufacturer A are interchangeable with stair climbing machines made by Manufacturer B because both machines work the same muscles and tendons. In Gym A, and in its software, the stair climbing machines from both manufacturers would be considered to be of the same “type.” However, Gym B may decide that stair climbing machines of Manufacturer A are not interchangeable with stair climbing machines of Manufacturer B because: (i) the Manufacturer A machines tend to have a smoother motion; and (ii) the Manufacturer B machines are adjustable in resistance (unlike the Manufacturer A machines). In Gym B, and in its software, the stair climbing machines from each manufacturer would be considered to be of different “types.”

Physiological data: any data relating to the physiological condition or operation of a human user's human body.

Medical data: data of one, or more, of the following types: injury related, disease history related, data reflecting medical advice from a medical professional to a specific individual.

What is claimed is:

1. A method comprising:
receiving, in a machine readable form, a physiological data set corresponding to a first user, with the physiological data set including information indicative of a first physiological parameter value for a first physiological parameter of the first user;
determining, by machine logic, a first session-time parameter value, based, at least in part, upon the physiological data set, with the first session-time parameter value representing a recommended time duration of a first exercise session by the first user on an exercise resource of a first type; and
scheduling, by machine logic, a plurality of exercise sessions respectively corresponding to a plurality of users including the first user, for a set of exercise resource(s) of the first type, with the scheduling being based, at least in part, upon the first session-time value;
wherein:
the first type is one of the following types: treadmill, weight lifting, abdominal, pool, track or spinning;
the first physiological parameter is one of the following types: injury-related, disease history related, age, mass, body size, body shape, cardiovascular/circulatory system related, digestive/excretory system related, endocrine system related, integumentary/exocrine system related, lymphatic/immune system related, muscular/skeletal system related, nervous system related, renal/urinary system related, reproductive system related, respiratory system related, and/or data reflecting medical advice from a medical professional to a specific individual;
the scheduling of exercise sessions is based, at least in part, upon predetermined schedule-able time slots of various time durations for each exercise resource of the set of exercise resource(s);
the scheduling is based, at least in part, upon the first session-time value because the first session-time value is matched, at least approximately, to a schedule-able time slot of an appropriate time duration;
the scheduling is based, at least in part, upon the first session-time value because the first session-time value is used to define a time duration of a first time slot for a selected exercise resource of the set of exercise resource(s) of the first type; and
the scheduling includes scheduling the first user to use the selected exercise resource during the first time slot.
